(19) United States
(12) Patent Application Publication
(10) Pub. No.: US 2010/0133266 A1
(43) Pub. Date: Jun. 3, 2010

(54) CONTAINER WITH RETRACTABLE SUPPORTS

(76) Inventors: Alan J. Cook, Woolton (GB); Gerald R. Koefelda, Sunningdale (GB)

Correspondence Address: CARLSON, GASKEY & OLDS, P.C., 400 WEST MAPLE ROAD, SUITE 350, BIRMINGHAM, MI, 48009, US

(21) Appl. No.: 12/628,553

(22) Filed: Dec. 1, 2009

Related U.S. Application Data
(60) Provisional application No. 61/119,182, filed on Dec. 2, 2008.

(51) Int. Cl. B65D 6/18; B23P 19/04

(52) U.S. Cl. 220/6; 29/700

(57) ABSTRACT

A container is provided which includes a base, a pair of opposed side walls, and a pair of opposed end walls which are transverse to the side walls. A support is pivotably mounted to each of the end walls. The support is configured to extend into the container and to fully retract out of the container. The support extends far enough into the container to reliably support another container thereon. The side and end walls may be pivotably connected to the base between an upright position generally perpendicular to the base and a collapsed position on the base.

This application claims priority to U.S. Provisional Application No. 61/119,182 which was filed on 2 Dec. 2008.

### BACKGROUND OF THE INVENTION

The present invention relates generally to containers with retractable supports and more particularly to a collapsible container with retractable support members for supporting another container thereon.

Collapsible containers are well known. Four walls are each connected via a hinge to a base and are selectively movable about the hinge between an upright (or use) position, in which the wall is generally perpendicular to the base, and a collapsed position onto the base. Various latch mechanisms have been provided to connect adjacent walls at the corner to selectively lock the container in the use position.

Some collapsible containers and some non-collapsible (usually nestable) containers include retractable supports so that another container can be supported thereon. One such container includes end walls, each of which have a support that is partially supported on the adjacent walls when in the support position. However, in some of the designs, particularly the collapsible containers, the support does not extend far enough into the mouth of the container, away from the end wall. As a result, it is difficult to reliably stack the other container onto the supports without the other container slipping down between the supports. It would be desirable for the supports to extend further into the container, without interfering with the goods in the container below the supports, and such that the supports are still able to fully retract out of the interior of the container and into the end walls.

### SUMMARY OF THE INVENTION

The present application provides a collapsible container including a base, a pair of opposed side walls, and a pair of opposed end walls which are transverse to the side walls. The side and end walls are pivotably connected to the base between an upright position, generally perpendicular to the base, and a collapsed position on the base. A support is pivotably mounted to each of the end walls. The supports are movable to a support position extending into the container and to a retracted position.

The end walls each include an arm which urges the support into the support position. Further, the support is pivotably mounted about a fixed pivot axis. The support includes a support portion and an arm portion. The support portion extends to the pivot axis by way of the arm portion. The support is sized such that when the support is in the retracted position, the support portion is received under a lip extending from the uppermost edge of the end wall and the arm portion is at least partially received through an opening in the end wall. Thus, the end wall does not inhibit the ability of the support to be fully retracted out of the container, while the size of the support allows it to extend far enough into the container so that it can be used to reliably support another container.

### BRIEF DESCRIPTION OF THE DRAWINGS

Other advantages of the present invention can be understood by reference to the following detailed description when considered in connection with the accompanying drawings wherein:

FIG. 1 is a perspective view of the container of the present application in an upright, assembled position;

FIG. 2 is a perspective view of the container of the present application in a collapsed position;

FIG. 3 is a perspective view of a quarter of the interior of the collapsible container of FIG. 1;

FIG. 4 is an interior side view of the corner of the container of FIG. 1;

FIG. 5 is an enlarged view of the interior corner of the container of FIG. 1, showing the support in the support position;

FIG. 6 is an upward perspective view of the interior corner of the container of FIG. 1, showing the support in the support position;

FIG. 7 is a perspective section view through the end wall of the container of FIG. 1, showing the support in the support position;

FIG. 8 is a perspective section view through the end wall of the container of FIG. 1, showing the support being pivoted outwardly toward the retracted position.

FIG. 9 is a perspective section view through the end wall of the container of FIG. 1, showing the support in the retracted position;

FIG. 10 is a side section view through the end wall of the container of FIG. 1, showing the support in the retracted position;

FIG. 11 is a perspective section view through the end wall of the container of FIG. 1, showing the arm of the support extending partially through the end wall in the retracted position;

FIG. 12 is an exterior view of a corner of the collapsible container of FIG. 1, showing the a second container supported on the container; and

FIG. 13 is a section side view through the end wall of the collapsible container of FIG. 1, showing in detail the support in the support position with a second container being supported on the support.

### DETAILED DESCRIPTION OF A PREFERRED EMBODIMENT

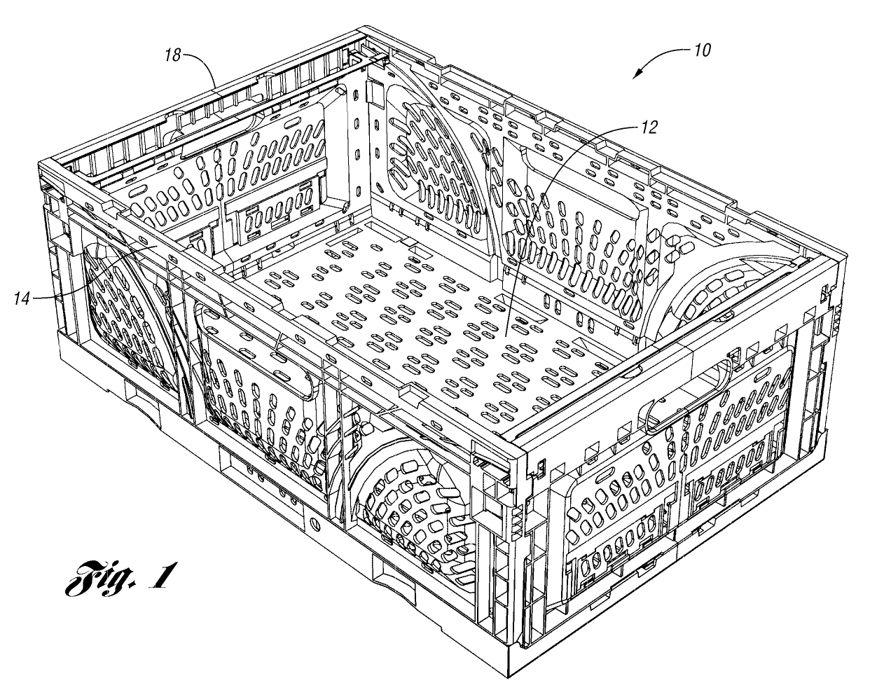

FIG. 1 is a perspective view of the container 10 in an upright position. The container 10 includes a base 12, upstanding side walls 14 (or long walls) and upstanding end walls 18 (or short walls). The side walls 14 and end walls 18 are pivotably connected along long and short edges of the base 12, respectively. In the example shown herein, the container 10 is a collapsible container.

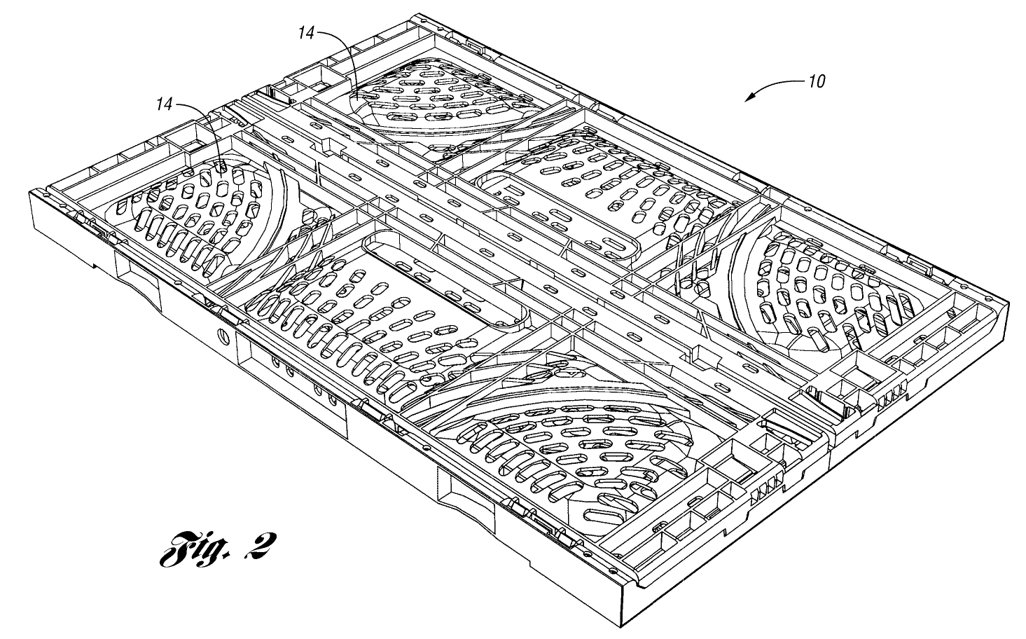

FIG. 2 portrays the collapsible container 10 in the collapsed position. The end walls 18 are collapsed onto the base 12, and the side walls 14 are collapsed onto the end walls 18. By collapsing the container 10 in this manner, the volume of the container 10 is reduced and the container 10 can be easily stored.

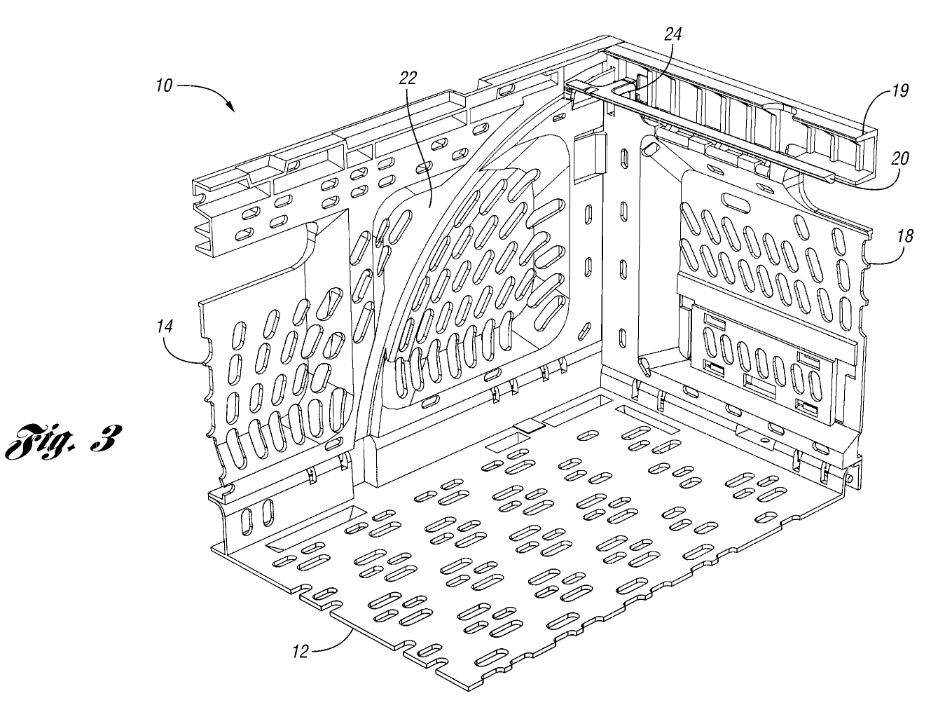

FIG. 3 is a perspective view of a quarter of the container 10. The remainder of the container 10 would be symmetric. Each end wall 18 has an upper lip 19 extending inwardly from an uppermost edge of the end wall 18. A support 20 is pivotably mounted to the end wall 18 and movable between a retracted position and a support position. In FIG. 1, the support 20 is shown to be pivoted to the support position, where it projects into the interior of the container 10 where it can support another container stacked thereon. The supports 20 project into arcuate channels 22 formed in each side wall 14. The ends of the supports 20 move in the arcuate channels 22 as the end walls 18 are collapsed onto the base 12. Each support 20 includes a plurality of arms 24 pivotably connecting the support 20 to the end wall 18.

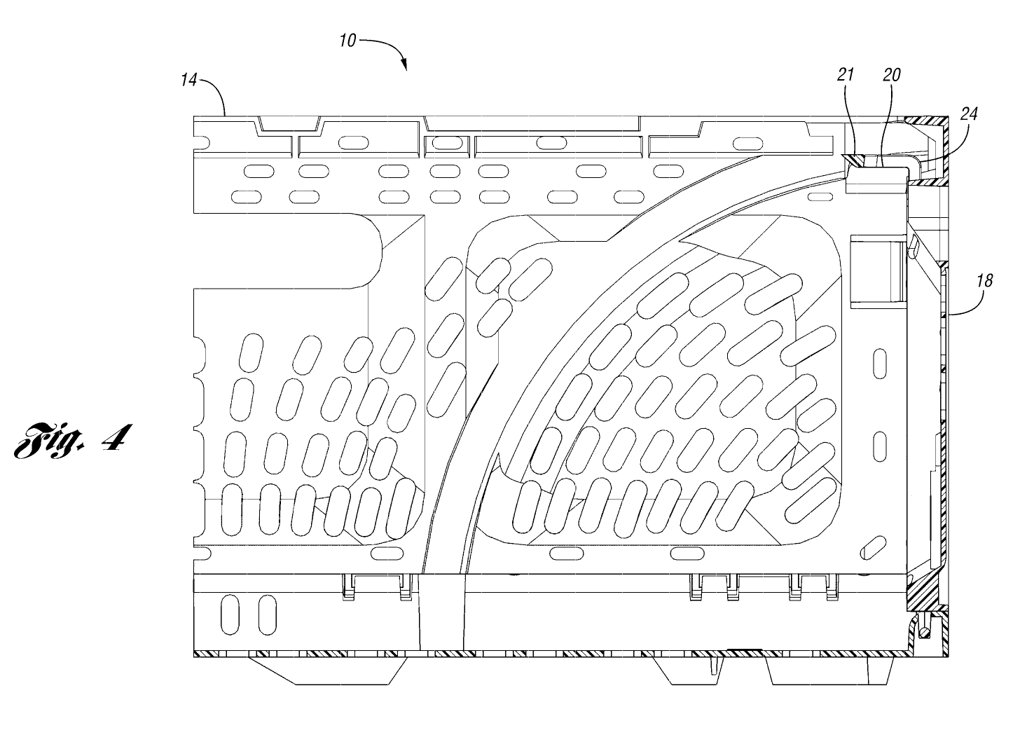

FIG. 4 is an interior view of the corner of the container 10 of FIG. 1. The support 20 includes a support portion 21 pivotably connected to the end wall 18 by arms 24.

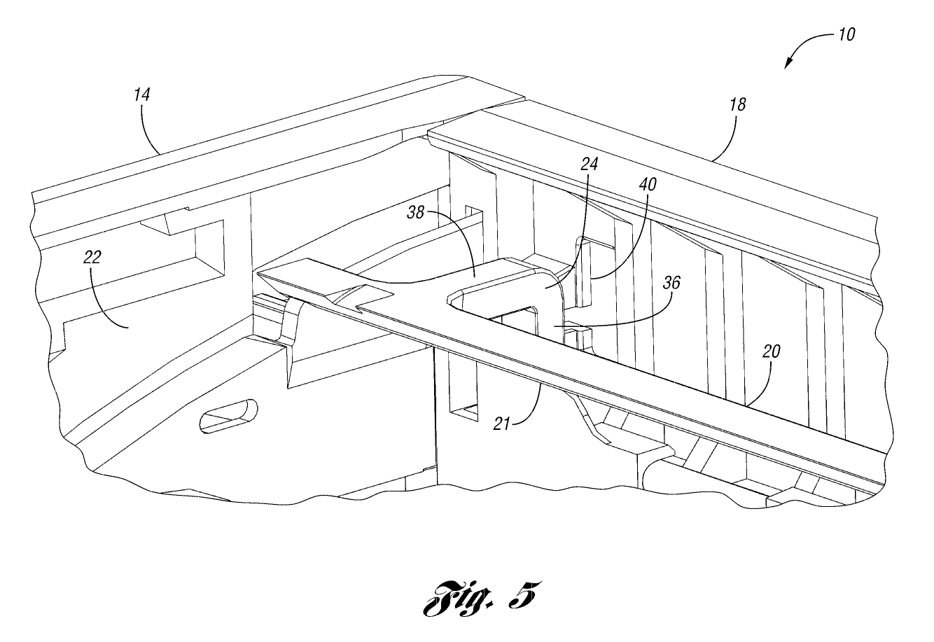

FIG. 5 is an enlarged view of the interior corner of the container 10 of FIG. 1. The support portion 21 of the support 20 is generally elongated and horizontal. The arms 24 are generally “L” shaped and include a vertical portion 36 pivotably connected to the end wall 18 and a generally perpendicular horizontal portion 38 leading to the support portion 21. An opening 40 is formed through the end wall 18 aligned with each arm 24 of the support 20.

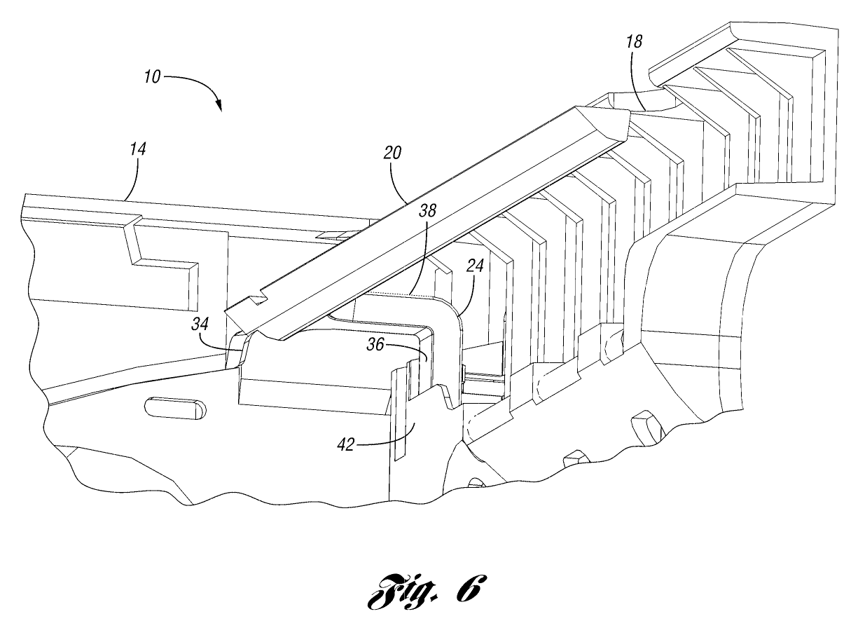

FIG. 6 shows an upward perspective view of the interior corner of FIG. 1. The end wall 18 includes a stop 42 contacting the vertical portion 36 of the arm 24 when the support 20 is in the support position to transfer some of the load on the support 20, but primarily to prevent over rotation of the support 20 inwardly, particularly when the support 20 is not resting on the rail 34 of the side wall 14 (e.g. as the end wall 18 is being pivoted downward to a collapsed position on the base 12).

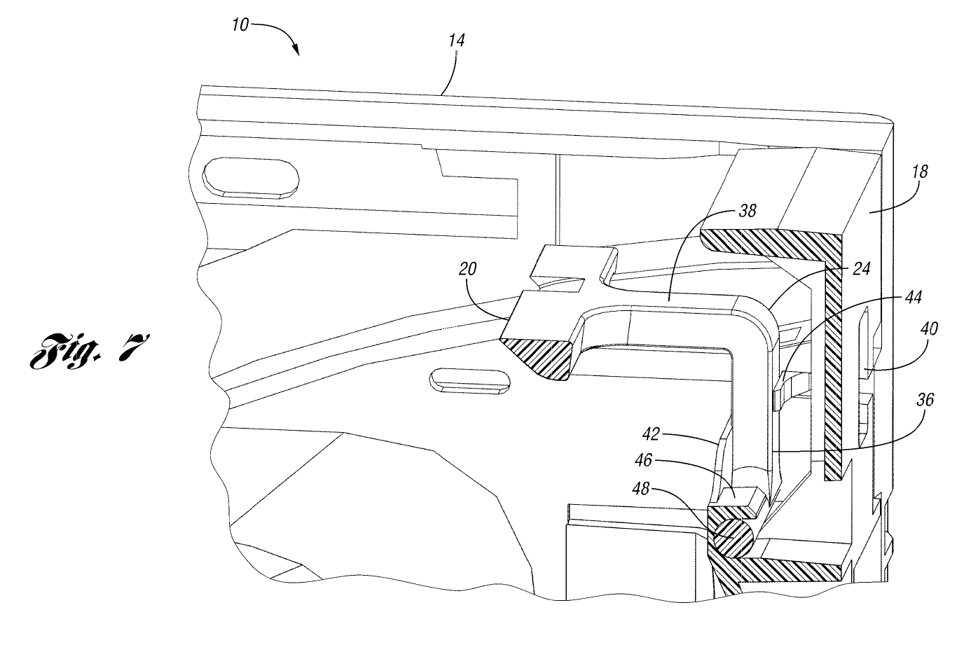

FIG. 7 is a section view of the end wall 18. As shown, the vertical portion 36 of the support 20 is pivotably connected to the end wall 18 via a hinge pin 48 integrally molded with the support 20 and which is pivotably captured in a hinge receiver 46 integrally molded with the end wall 18. The side wall 14 may optionally include an integrally molded and elastically deformable arm 44 that contacts the vertical portion 36 of the arm 24 and urges the arm 24 toward the support position. Note that when the end wall 18 is collapsed onto the base, the support 20 is no longer biased toward the support position.

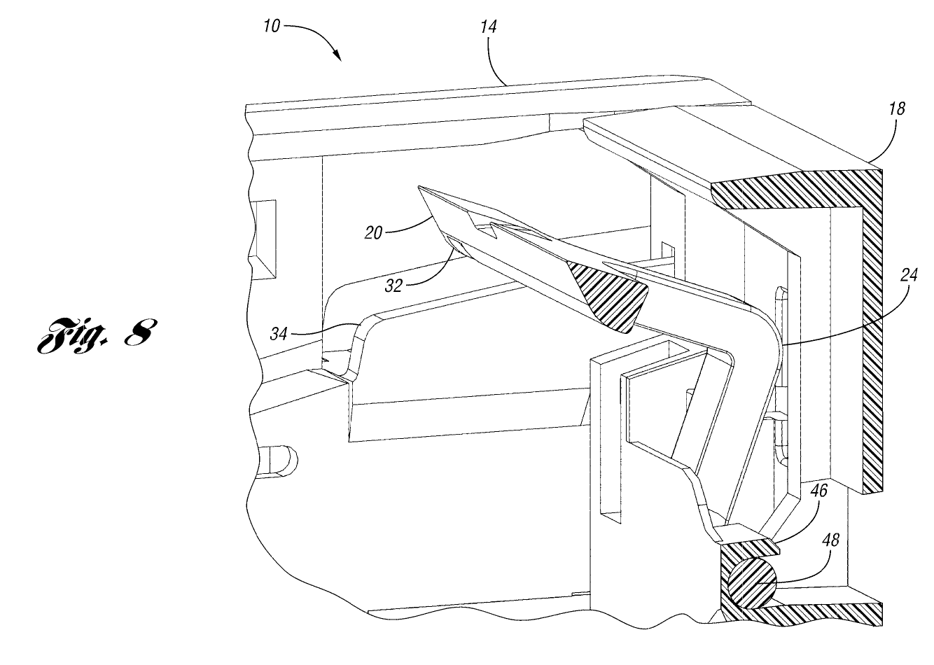

FIG. 8 shows the support 20 being pivoted outwardly toward the retracted position. As can be seen in FIG. 8, the outer ends of the support 20 include downwardly projecting tabs 32 that are received behind the rails 34 in the side walls 14 to interlock the support 20 to the side walls 14. This prevents the side walls 14 from deflecting outwardly when a load, usually another container, is placed on the supports 20. This also prevents the supports 20 from bowing and falling inwardly.

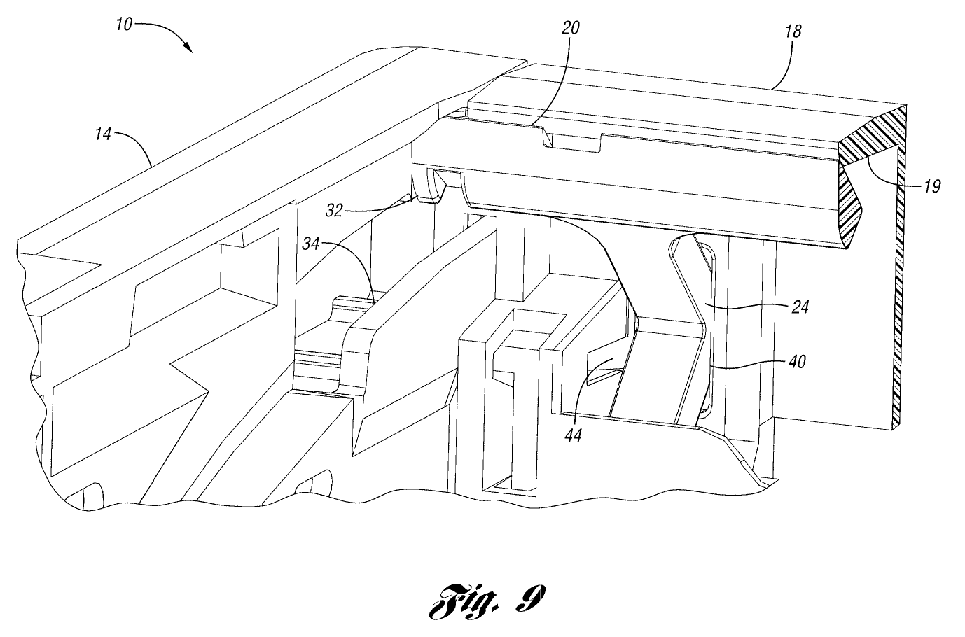

Referring to FIG. 9, as the support 20 is pivoted toward the retracted position, the arm 44 is deflected outwardly. The arm 44 continues to urge the support 20 toward the support position, such that when the support 20 is released, it automatically returns to the support position. When the support 20 reaches the retracted position below the upper lip 19 of the end wall 18, as shown in FIG. 9, the angled portion of the arm 24 is received within the opening 40 through the end wall 18.

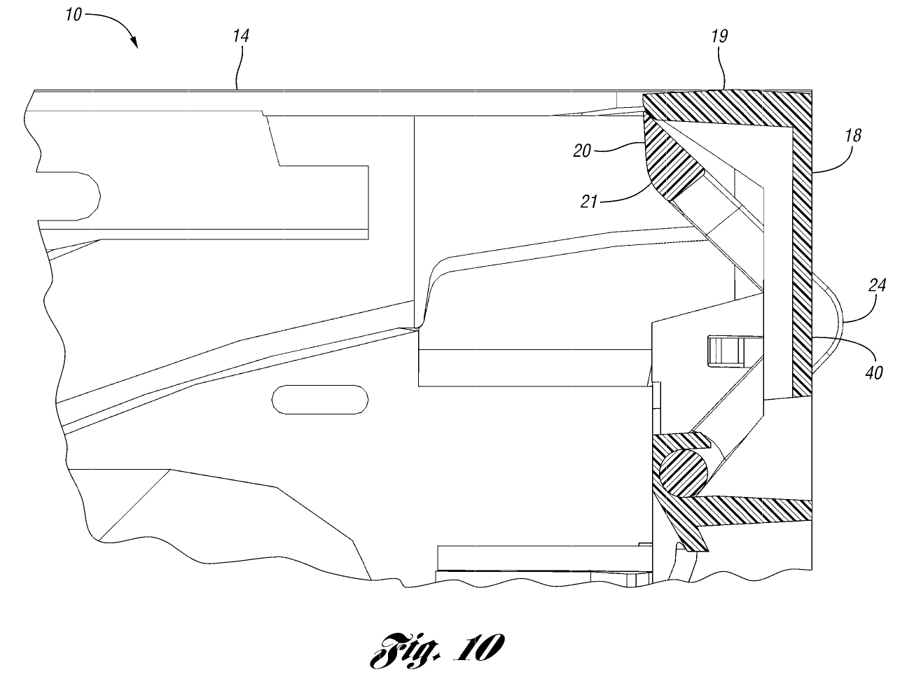

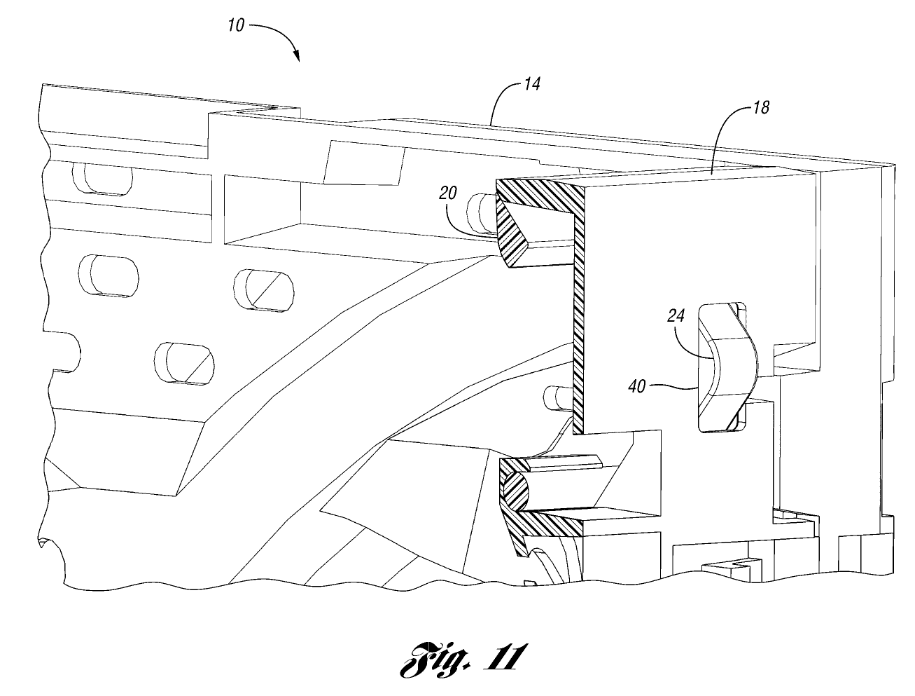

As shown in FIGS. 10 and 11, in the retracted position, the arms 24 project slightly through the openings 40 through the end wall 18. This should not be a problem because the supports 20 are only moved to the retracted position during filling of the container 10. In the retracted position, the support portion 21 of the support 20 is directly below the upper lip 19 of the end wall 18. Thus, in the retracted position, the support 20 does not occupy any interior space of the container 10 and does not project into the mouth of the container 10.

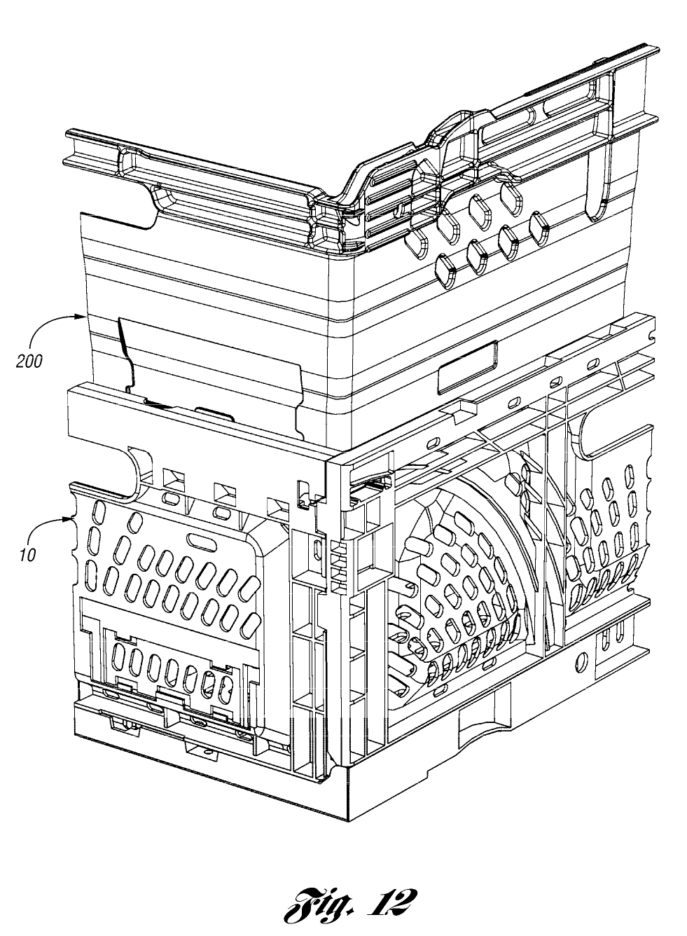

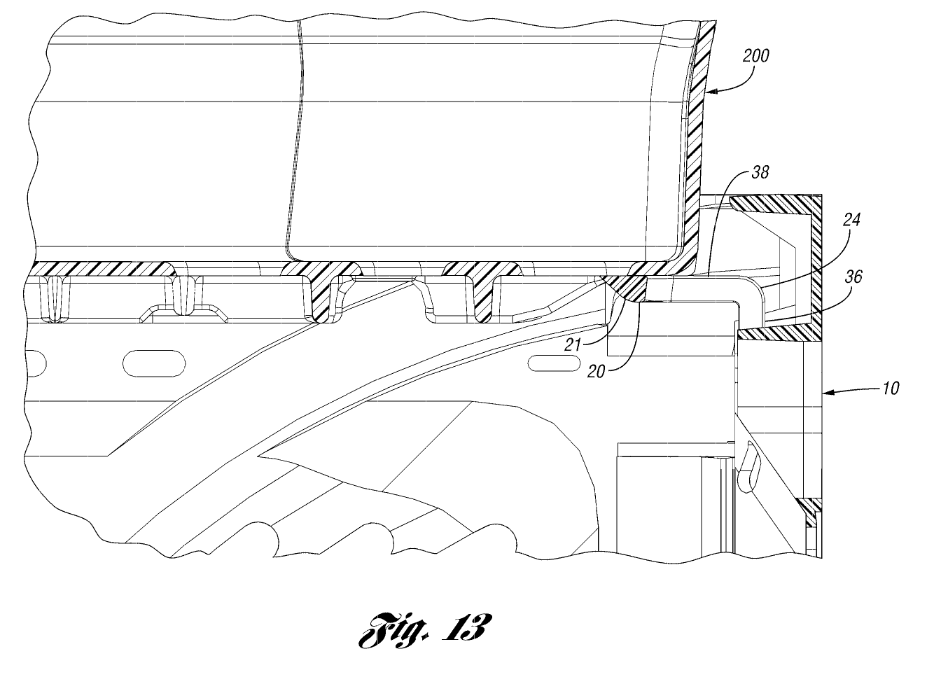

When the supports 20 are in the support position, a second container 200 can be supported on the supports 20, as shown in FIGS. 12 and 13. As shown in FIG. 13, the support 20 extends further into the interior of the container 10 than some of the supports in the known containers. Because the arm 24 has two transverse portions, the arm 24 does not encroach on the interior space of the container 10 when in the support position. Further, by permitting a portion of the arm 24 (specifically, the portion where the vertical portion 36 and the horizontal portion 38 meet) to extend partially into (and even through) the opening 40 in the end wall 18, the arm 24 moves through a larger pivot angle, which also results in the support 20 projecting further into the container 10. This provides a more stable surface on which to support the other container 200 (FIG. 13).

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. For example, the supports 20 illustrated above could be provided on a non-collapsible container.

What is claimed is:

1. A container comprising:
a base;
a side wall;
an end wall transverse to the side wall;
a support movable between a support position extending into the container and a retracted position, the support including a support portion for supporting another container thereon and an arm portion connecting the support portion to the container; and
wherein the support is sized such that when the support is in the retracted position the arm portion is at least partially received through an opening through the end wall.

2. The container of claim 1, wherein each of the side wall and the end wall are pivotably connected to the base between an upright position generally perpendicular to the base and a collapsed position on the base.

3. The container of claim 2, wherein the arm portion extends from a hinge pin, the hinge pin defining a pivot axis.

4. The container of claim 3, wherein the arm portion includes a vertical arm portion and a horizontal arm portion, the vertical arm portion extending from the hinge pin to the horizontal arm portion, the horizontal arm portion extending from the vertical arm portion to the support portion, the horizontal arm portion extending generally perpendicularly to the vertical arm portion.

5. The container of claim 4, wherein the end wall includes a stop which contacts the vertical arm portion when the support is in the support position, thereby preventing the support from pivoting past the support position.

6. The container of claim 3, wherein the pivot axis is a fixed pivot axis.

7. The container of claim 1, wherein the arm portion is generally L-shaped.

8. The container of claim 7, wherein the arm portion includes a vertical arm portion and a horizontal arm portion extending generally perpendicular to one another, the horizontal arm portion extending into the container.

9. The container of claim 8, further including that when the support is in the retracted position an intersection of the vertical arm portion and the horizontal arm portion is received through an opening in the end wall.

10. A container comprising:
a base;
a side wall;
an end wall transverse to the side wall; and
a support movable between a support position extending into the container and a retracted position, the support including a support portion for supporting another container thereon and an arm portion connecting the support portion to the container, the arm portion including a first arm portion and a second arm portion generally perpendicular to the first arm portion.

11. The container of claim 10, wherein each of the side wall and the end wall are pivotably connected to the base between an upright position generally perpendicular to the base and a collapsed position on the base.

12. A method for using a container having a base, a side wall, and an end wall extending transverse to the side wall;
a) moving the side wall and the end wall from a collapsed position on the base to an upright position and;
b) moving a support from a retracted position to a support position extending into the container, the support including a support portion and an arm portion, the arm portion connecting the support portion to the container; and
c) moving the support to the retracted position, where the arm portion is partially received through an opening formed through the end wall.

13. The method of claim 12, wherein the arm portion is generally L-shaped.

14. The method of claim 12, wherein the arm portion includes a vertical arm portion and a horizontal arm portion when the support is in the support position.
